(19) United States
(12) Patent Application Publication
(10) Pub. No.: US 2026/0181224 A1
(43) Pub. Date: Jun. 25, 2026

(54) Systems and Methods for Generating a Visual Summary

(71) Applicant: Spotify AB, Stockholm (SE)

(72) Inventor: Dimitrios KORKINOF, Surrey (GB)

(21) Appl. No.: 19/070,344

(22) Filed: Mar. 4, 2025

(30) Foreign Application Priority Data
Dec. 23, 2024 (GR) 20240100920

(51) Int. Cl. H04N 21/8549; G06V 10/44; G06V 10/60; G06V 10/762; H04N 21/845

(52) U.S. Cl. CPC H04N 21/8549; G06V 10/44; G06V 10/60; G06V 10/762; H04N 21/8456

(57) ABSTRACT

A method includes extracting, from a first video content item that includes a plurality of frames, a plurality of features. The method further includes segmenting the first video content item into respective shots using change-point detection of the plurality of features, including: representing the plurality of features as a one-dimensional or multi-dimensional signal over time; identifying a change from one respective shot to another respective shot based on occurrence of one or more transitional indicators of the one-dimensional or multi-dimensional signal. The first video content item is segmented into respective shots at the identified changes. The method further includes selecting, from each respective shot, a respective key frame. The method further includes generating a visual summary of the first video content item based on one or more of the respective key frames.

### RELATED APPLICATION

This application is claims priority to Greek Patent Application No. 20240100920, filed Dec. 23, 2024, which is incorporated by reference in its entirety.

### TECHNICAL FIELD

The disclosed embodiments relate generally to using change-point detection to segment a video.

### BACKGROUND

Access to electronic media, such as audio content and video content, has expanded dramatically over time. With large catalogs of content available to be streamed to users, providing summaries and/or previews of content items improves the user experience by enabling the user to consume a shorter version of the full-length content. It is challenging to automatically generate summaries of content items by segmenting the content, especially video content items, without over-segmenting or under-segmenting the content item.

### SUMMARY

Existing approaches for performing key frame extraction lack proper shot segmentation. With a shot being defined as a consecutive video segment, where all frames are sufficiently similar to each other. For example, thresholding pixel differences between frames in a video content item is not effective in correctly distinguishing between different shots as it relies on the assumption of abrupt changes between shots. This assumption does not hold in the case of slow transitions between shots, such as with fade-in/out effects or other gradual transitions. In those cases, the differences between consecutive frames will always be small and either these segments will be under-segmented or the threshold to identify changes must be reduced, which can then result in over-segmentation of other parts of the video.

Change-point detection is an umbrella term for a variety of methods that attempt to fit different models to different parts of a sequence in an optimal way. If, for example, the frame features of a video content item comprise a one-dimensional signal evolving in time, an abrupt change between shots will look like a step function, while a gradual transition as a linear or quadratic one. Thus, change point detection can be used to more effectively distinguish between shots in a video regardless of how abrupt or gradual the transition between them is.

The disclosed embodiments provide a two-step process that is used to determine shot key frames. First, shot boundaries (also referred to herein as segment boundaries) are identified using change-point detection, and second, a key frame for each shot is selected from within the shot boundaries for the respective shot. The shot key frames may then be clustered into scenes, and a scene key frame may be selected and used to generate a visual summary of the video (e.g., with a scene comprising one or multiple shots). Thus, a system for performing key frame extraction using change-point detection is provided to generate two levels of frame summaries: a first level having a key frame representing each shot that is identified using change-point detection and a second level that clusters the shot key frames into the scene key frames.

To that end, in accordance with some embodiments, a method is provided. The method includes extracting, from a first video content item that includes a plurality of frames, a plurality of features. The method further includes segmenting the first video content item into respective shots using change-point detection of the plurality of features, including: representing the plurality of features as a one-dimensional or multi-dimensional signal over time; identifying a change from one respective shot to another respective shot based on the occurrence of one or more transitional indicators of the one-dimensional or multi-dimensional signal. The first video content item is segmented into respective shots at the identified changes. The method further includes selecting, from each respective shot, a respective key frame. The method further includes generating a visual summary of the first video content item based on one or more of the respective key frames.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein.

Thus, systems are provided with improved methods of generating a visual summary of content.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIGS. 4A-4B are example user interfaces illustrating segmenting video content using change-point detection, in accordance with some embodiments.

FIGS. 5A-5B are flow diagrams illustrating a method for generating a visual summary, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

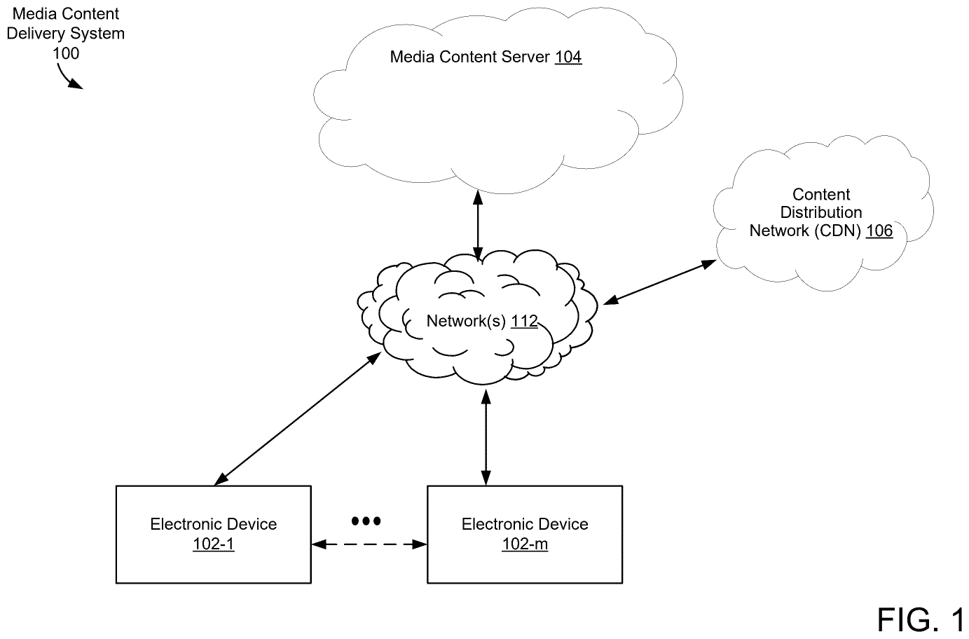

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

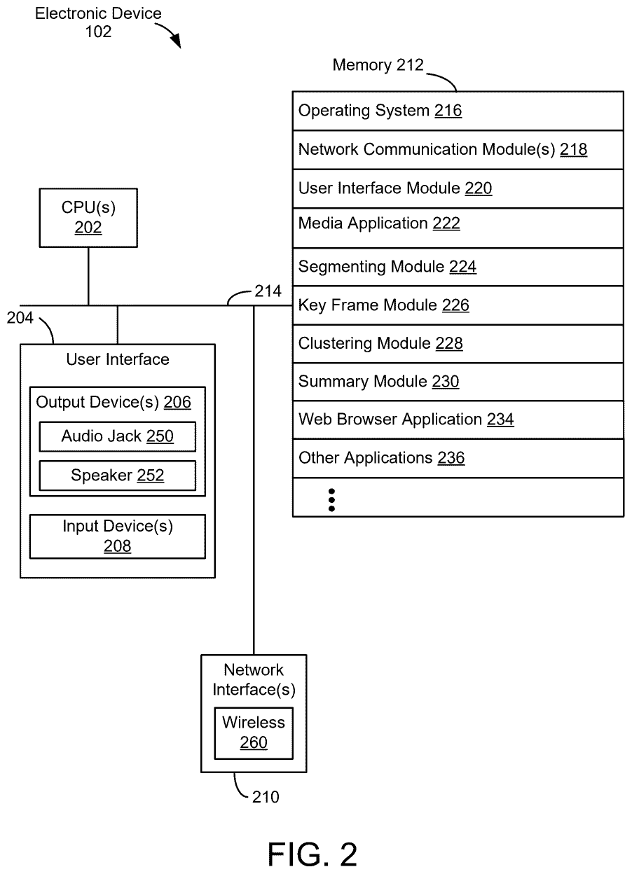

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 10-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2-or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory may optionally include one or more storage devices remotely located from the CPU(s) 202.

Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items).
a segmenting module 224 for extracting features from frames of video content items and segmenting the frames into shots, including identifying shot boundaries within the video content items;
a key frame module 226 for identifying one or more key frames (e.g., a key frame within each shot), including selecting a respective key frame based on its position within the scene, desired characteristics of the frame, and/or its average distance relative to other frames in the shot;
a clustering module 228 for clustering one or more key frames using a clustering algorithm;
a summary module 230 for generating and/or storing visual summaries using clustered key frames for respective video content items;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

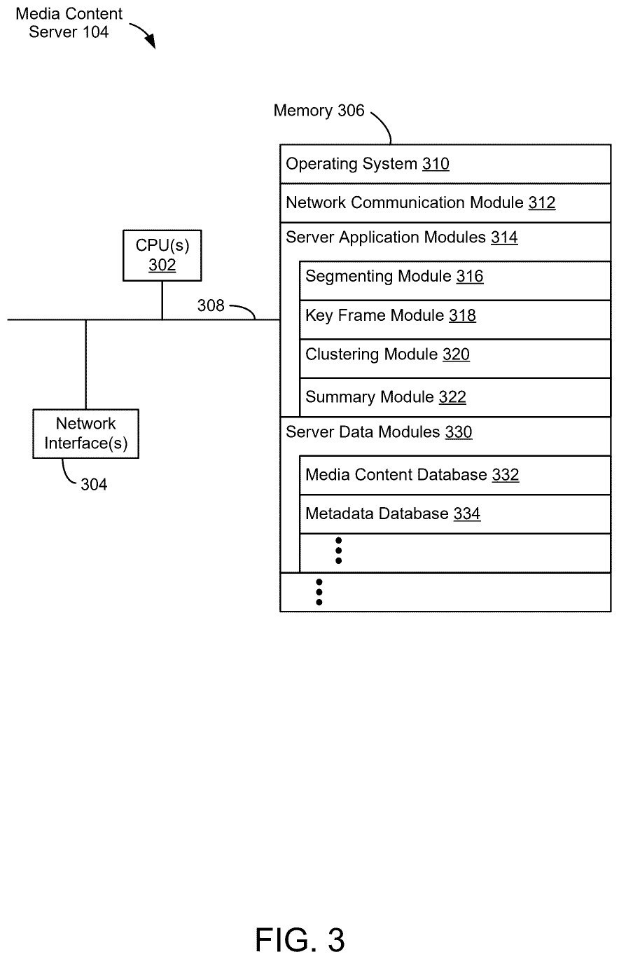

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a segmenting module 316 for extracting features from frames of video content items and segmenting the frames into shots, including identifying shot boundaries within the video content items;
   a key frame module 318 for identifying one or more key frames (e.g., a key frame within each shot), including selecting a respective key frame based on its position within the scene, desired characteristics of the frame, and/or its average distance relative to other frames in the shot;
   a clustering module 320 for clustering one or more key frames using a clustering algorithm;
   a summary module 322 for generating and/or storing visual summaries using clustered key frames for respective video content items;
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including e.g., a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

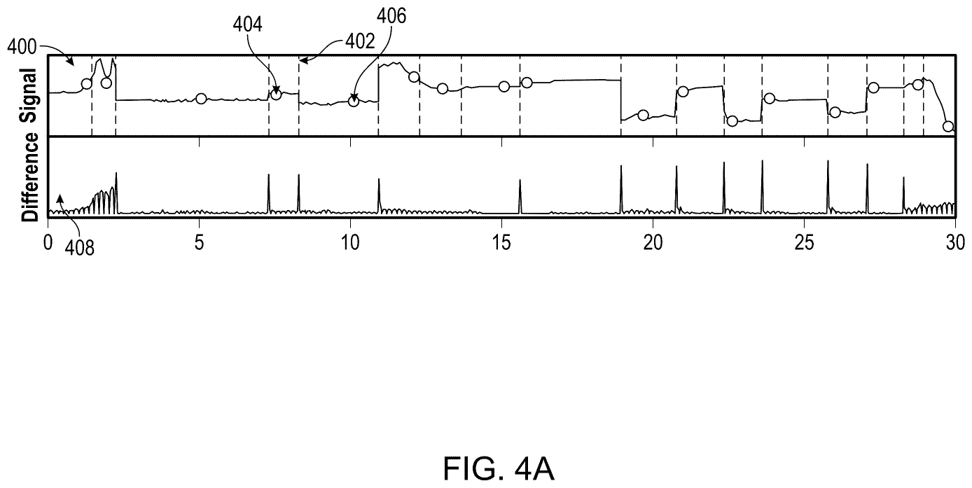

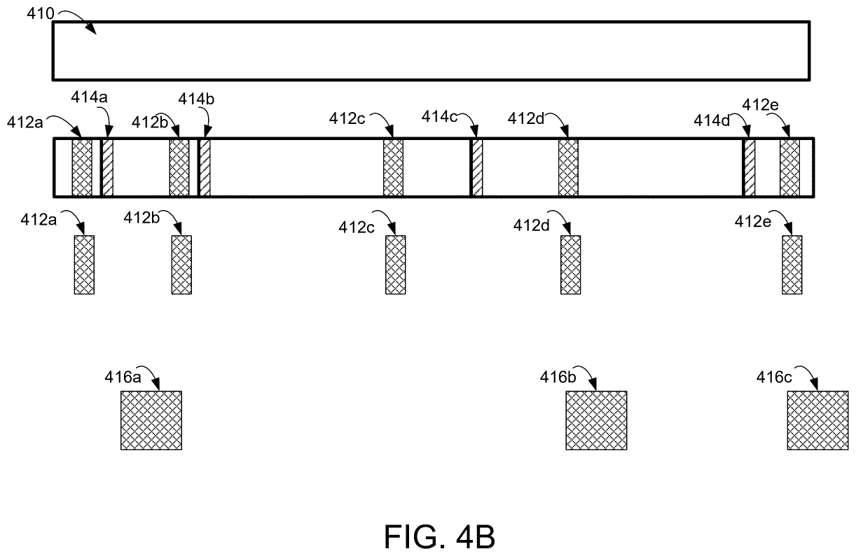

FIG. 4A illustrates a one-dimensional signal representation of the plurality of features of a first video content item in accordance with some embodiments. In some embodiments, a system identifies a plurality of features of the first video content item. In some embodiments, the system identifies the plurality of features by extracting features from individual frames of the first video content item, for example, by processing raw pixels of the frames (e.g. using image histograms, and/or using discrete cosine transform (DCT)).

In some embodiments, the system uses change-point detection to segment the first video content item into respective shots (e.g., also referred to herein as respective segments). For example, the system identifies changes in a plurality of features, represented for visual simplicity as a one-dimensional signal 400 (e.g., 256-dimensional vectors), where the changes correspond to a specific parametrization of a selected model (e.g. a constant or any other function). For example, content segments are identified in the video content item, where transitions between the segments can be gradual or abrupt. For example, occurrence of an abrupt transition is illustrated by peaks in the difference signal 408 (e.g., segment boundary 402), while occurrence of a gradual transition cannot be reliably detected from the difference signal 408 as it does not cause an abrupt peak in the difference signal 408. Thus, using change-point detection on the raw plurality of features allows for potential detection of any differences in the underlying signal that may indicate a different segment.

In some embodiments, the identified parametrization of the model (e.g. constant or any other function) corresponds to a segment boundary. For example, the system divides the video content item into segments according to the segment boundaries (e.g., represented by vertical indicators in FIG. 4A, such as segment boundary 402) identified by change-point detection (e.g., according to the occurrence of a constant function with different mean in the one-dimensional or multi-dimensional signal). In some embodiments, a frame (e.g., represented by the dots on signal 400 shown in FIG. 4A, such as frame 404 and/or frame 406) is selected within each segment. In some embodiments, a respective frame of each respective segment, is selected for having one or more desirable characteristics, such as: a target location (e.g., middle-shot position), a desired level of brightness and/or sharpness (e.g. variance of the Laplacian), the smallest average feature or embedding distance to other frames and desirable characteristics as determined by a Machine Learning (ML) model (e.g., an ML model trained to identify a frame having target/desired context, activity, setting, appearance or the like), as described below with reference to FIG. 4B.

FIG. 4B illustrates a block diagram of segmenting a video content item 410 in accordance with some embodiments. In some embodiments, shot-changes 414 (e.g., shot-change 414a, shot-change 414b, shot-change 414c, and shot-change 414d) are identified as the segment boundaries of the video content item, using change-point detection as described with respect to FIG. 4A. In some embodiments, each shot (e.g., segment) includes a sequence of frames that are visually similar.

In some embodiments, within each shot, a shot key frame 412 (e.g., key frame 412a, key frame 412b, key frame 412c, key frame 412d, key frame 412e) is detected. For example, the key frame is determined as a quality representation for the shot. In some embodiments, the key frame is selected as the middle frame within the shot (e.g., a fast and simple way to identify the key frame), or otherwise based on the position of the key frame relative to other frames in the shot. In some embodiments, the key frame is selected for its high quality according to any given criterion. For example, for having the greatest level of brightness or sharpness within the shot (e.g., whereby the sharpness is determined by determining the variance of the Laplacian for the frames in the shot). In some embodiments, the key frame is selected as the most representative frame by comparing a respective frame (e.g., features of the respective frame) to frames in the shot before and after the respective frame, and selecting a respective frame that has the smallest average distance to the other frames (e.g., the frames before and after the respective frame) as the key frame.

In some embodiments, the shot key frames 412 are combined to generate a visual summary (e.g., a shot-level summary) that includes key frames representing each shot that is identified using change-point detection.

In some embodiments, a subset, less than all, of the key frames 412 are used to generate a visual summary (e.g., a scene-level summary) of the video content item 410. For example, the key frame 412b is clustered with one or more other key frames (e.g., key frame 412a) of the video content item to generate clustered frames 416. As such, key frames that are perceptually similar (e.g., determined based on connected components in a proximity graph of key frames) are clustered. For example, when the camera cuts from person A to person B and back to person A, it is segmented into three shots and three key frames, but two of those key frames would be person A, so the key frames for the three shots are clustered into two groups (e.g., scenes) one containing two key frames of person A and the other containing one key frame of person B. In some embodiments, the clustering is performed using one or more clustering algorithms, such as k-means, Density-Based Spatial Clustering of Applications with Noise (HDBSCAN), and/or topological data analysis (TDA).

In some embodiments, the generated clustered frames 416 are arranged to generate a scene-level summary of the video content item 410. As such, a subset, less than all, of the key frames 412 are used to generate the scene-level summary of the video content item 410. In some embodiments, the scene-level summary of the video content item is shorter in length (e.g., includes fewer frames) than the shot-level summary. In some embodiments, both the shot-level summary and the scene-level summary are stored in conjunction with the video content item 410. In some embodiments, a user requests the shot-level summary and/or the scene-level summary for the video content item for playback.

In some embodiments, segmenting the video into shots, selecting a key frame for each shot, and/or clustering a subset of the key frames is performed by a machine learning model that is trained end-to-end. For example, a Recurrent Neural Network (RNN), a State Space Model (SSM) and/or an attention-based model (e.g. a transformer) can be trained to attend to the sequence of frames, segment it into shots or scenes and select the most appropriate shot or scene key frames that according to some criterion (e.g. minimizing the information loss).

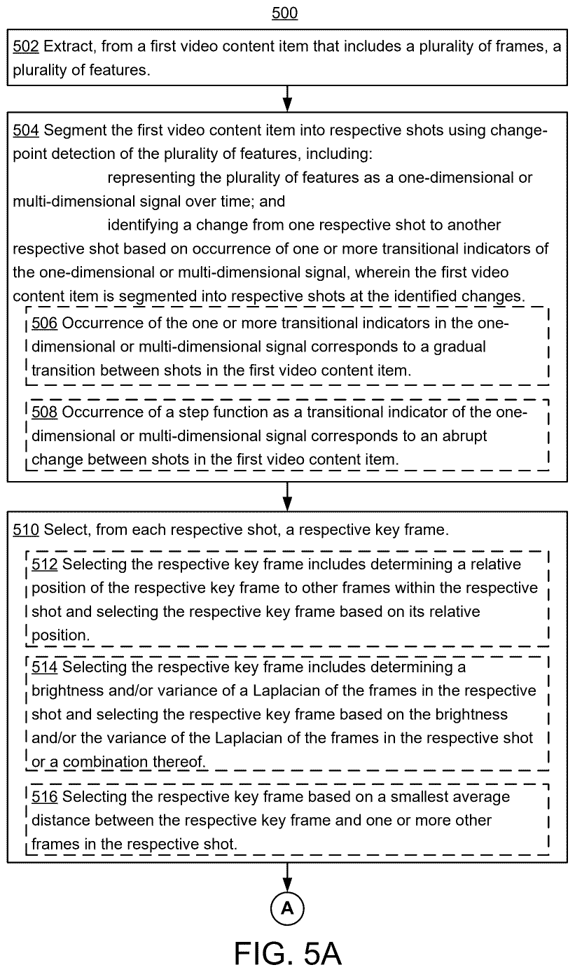

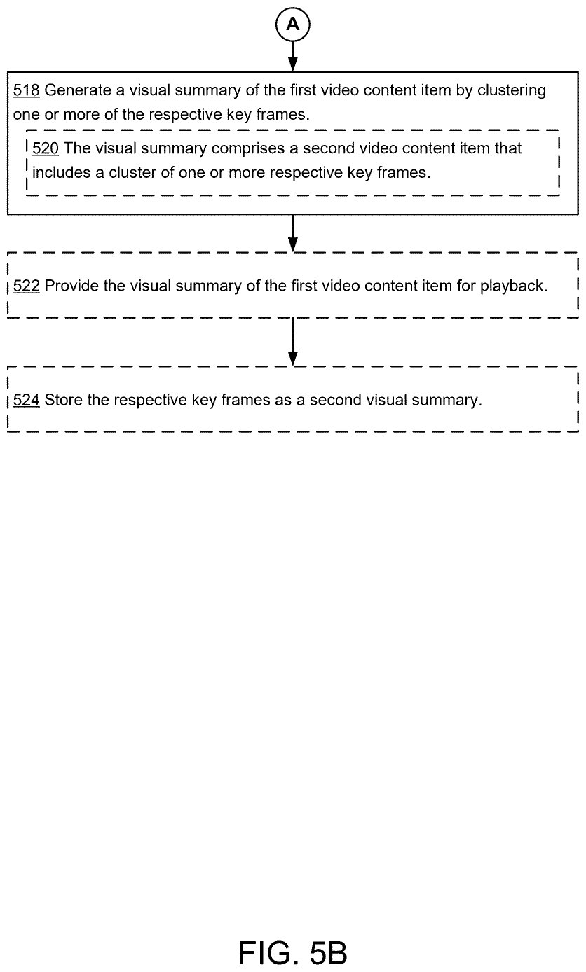

FIGS. 5A-5B are flow diagrams illustrating a method 500 of generating a visual summary of a content item, in accordance with some embodiments. In some embodiments, method 500 is performed by a computer system (e.g., electronic device 102 and/or media content server 104, or a combination thereof).

In some embodiments, the method includes extracting (502), from a first video content item (e.g., video content item 410) that includes a plurality of frames, a plurality of features (e.g., from each frame) (e.g., wherein the features comprise features derived from color histograms, DCT and/or features produced by Machine Learning models). In some embodiments, the method includes extracting multi-dimensional feature vectors from each frame. In some embodiments, the multi-dimensional feature vectors are PDQF vectors, which are essentially DCT low frequency content of the image. Alternatively, the features may be derived from color histograms, so for each color (RGB), the method extracts the percentage of pixels in each bin (e.g. 256 bins) and uses them as coefficients of the feature vector (3 colors a total of 768 dimensions).

The method includes segmenting (504) the first video content item into respective shots using change-point detection of the plurality of features, including: representing the plurality of features as a one-dimensional or transitional indicators in the one-dimensional or multi-dimensional signal over time (e.g., as described with reference to FIG. 4A); and identifying a change from one respective shot to another respective shot based on occurrence of one or more transitional indicators of the one-dimensional signal, wherein the first video content item is segmented into respective shots (e.g., also referred to as segments) at the identified changes (referred to as “change-points”). In some embodiments, identifying a change from one respective shot to another comprises determining that different parametrization of a selected model (e.g. a linear or nonlinear model, and/or parametric or non-parametric model) best fit to the sequence of features corresponding to each segment. For example, a segment boundary 402 is identified between shots using change-point detection.

Change-point detection is approached as a model-selection process, whereby one or multiple family of models is selected (e.g. linear, non-linear, parametric or non-parametric) and individual models (i.e. different parametrization of the models in the selected family of models) are used to represent different segments in the multi-dimensional signal (e.g. lines with different slopes for a linear model family, segments with different means for a mean-shift model). The optimal number of segments, segment boundaries and model parameters per segment are determined through an optimization process which aims to determine the configuration that best fits the raw one-dimensional or multidimensional signal (e.g., minimizing the discrepancy between the model allocated to each segment and the raw multi-dimensional signal).

In some circumstances, a shot is a consecutive (uninterrupted) segment in time, which depicts roughly the same thing, object, person, and/or place, e.g., all the frames are visually similar. In some circumstances, a scene consists of multiple shots that can be located in different parts of the video. Thus, a scene is not necessarily uninterrupted. An example is a podcast when the camera shows the host and guest. Every time the camera cuts from the host to the guest (or vice versa) that creates a new shot, but in the end there are only two scenes, one showing the host and the other the guest.

As a more specific example, at a first step of a change-point detection process, a model type is selected. Examples of model types include linear models (e.g. modeling lines with different slopes) or non-linear models (e.g., polynomial function with different coefficients) or non-parametric models (e.g., mean-shift). Second, an optimization algorithm (e.g., Pruned Exact Linear Time (PELT) ) tries to fit lines to different segments in an optimal way and at the same time tries to find the best segment boundaries (e.g., so that the error between the line we fit in each segment is lowest (i.e., the difference between the line and the signal is smallest). In some embodiments, the number of segments is a parameter that is automatically determined as well. Typically, there is no limit to the number of segments, but there is a penalty parameter that penalizes having too many segments.

In some embodiments, the change-point detection methods described herein operate directly on multi-dimensional feature vectors (e.g., in which each frame is represented by a 256-dimensional vector). In some embodiments, the change-point detection methods described herein first reduce the dimensionality of the vectors and then apply change-point detection. The former is a more difficult problem for the change-point detection method to solve, but the latter may introduce unnecessary loss of information reducing performance. Usually, if the signal is of very high dimensionality (in the order of thousands of dimensions) it may be preferable to reduce the dimensionality before applying change point detection.

In some embodiments, occurrence of the one or more transitional indicators in the one-dimensional or multi-dimensional signal corresponds to (506) a gradual transition between shots in the first video content item. For example, segmenting the shots is robust to gradual transitions between shots in the first video content item, for example, corresponding to the occurrence of the linear functions in the one-dimensional or multi-dimensional signal, as described with reference to FIG. 4B.

In some embodiments, an occurrence of a step function as a transitional indicator of the one-dimensional or multi-dimensional signal corresponds to (508) an abrupt change between shots in the first video content item. For example, segmenting the shots is robust to an abrupt change between shots in the first video content item, for example, corresponding to occurrence of the step functions in the one-dimensional or multi-dimensional signal, as described with reference to FIG. 4B.

The method includes selecting (510), from each respective shot, a respective key frame. For example, a frame 404 is selected from the shot prior to segment boundary 402 and frame 406 is selected from the shot after segment boundary 402 (FIG. 4A). In some embodiments, key frames 412 are identified for the video content item 410, as described with reference to FIG. 4B.

In some embodiments, selecting the respective key frame includes (512) determining a relative position of the respective key frame to other frames within the respective shot and selecting the respective key frame based on its relative position (e.g., select a middle of the shot position). In some embodiments, the respective key frame is not the first frame in the shot. In some embodiments, the respective key frame is not the middle frame in the shot. In some embodiments, the respective key frame is selected based on criteria other than the position of the frame within the respective shot.

In some embodiments, selecting the respective key frame includes (514) determining a brightness and/or variance of the Laplacian of the frames in the respective shot and selecting the respective key frame based on the brightness and/or the variance of the Laplacian of the frames in the respective shot.

In some embodiments, the method includes (516) selecting the respective key frame based on a smallest average distance between the respective key frame and one or more other frames in the respective shot.

The method includes generating (518) a visual summary of the first video content item by clustering one or more of the respective key frames. For example, clustered key frames 416a, 416b and 416c are combined to generate a scene-level visual summary of video content item 410, as described with reference to FIG. 4B.

In some embodiments, the visual summary comprises (520) a second video content item that includes a cluster of one or more respective key frames (e.g., to be viewed by the user). For example, the visual summary of the clustered key frames 416a are combined into a second video content item that is stored as a distinct video content item (e.g., and is associated with the video content item 410) and optionally is played back for (e.g., displayed on a display device for) a user.

In some embodiments. the method includes providing (522) (e.g., streaming, displaying, or otherwise playing back) the visual summary of the first video content item for playback (e.g., at a client device associated with a user). For example, a visual summary of a podcast (e.g., the first video content item) is provided as a preview for the podcast.

In some embodiments, the method includes storing (524) the respective key frames as a second visual summary (e.g., a shot-level summary, as described with reference to FIG. 4B). For example, the second visual summary is a longer summary that includes additional key frames (e.g., the key frames 412 (before clustering) are combined to generate a second visual summary (e.g., where the second visual summary is longer than the visual summary generated by the clustered key frames)). In some embodiments, the second visual summary is stored as a distinct video content item in conjunction with the video content item.

Although FIGS. 5A-5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof. In addition, in accordance with some embodiments, various operations described with respect to other methods may be combined with the operations described with respect to method 500.

The foregoing description, for the purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method, comprising:
extracting, from a first video content item that includes a plurality of frames, a plurality of features;
segmenting the first video content item into respective shots using change-point detection of the plurality of features, including:
representing the plurality of features as a one-dimensional or multi--dimensional signal over time;
identifying a change from one respective shot to another respective shot based on occurrence of one or more transitional indicators of the one-dimensional or multi-dimensional signal, wherein the first video content item is segmented into respective shots at the identified changes;
selecting, from each respective shot, a respective key frame; and
generating a visual summary of the first video content item based on one or more of the respective key frames.

2. The method of claim 1, wherein selecting the respective key frame includes determining a relative position of the respective key frame to other frames within the respective shot and selecting the respective key frame based on its relative position.

3. The method of claim 1, wherein selecting the respective key frame includes determining a brightness and/or variance of a Laplacian of the frames in the respective shot and selecting the respective key frame based on the brightness and/or the variance of the Laplacian of the frames in the respective shot or a combination thereof.

4. The method of claim 1, wherein selecting the respective key frame based on a smallest average distance between the respective key frame and one or more other frames in the respective shot.

5. The method of claim 1, wherein the visual summary comprises a second video content item that includes a cluster of one or more respective key frames.

6. The method of claim 1, further including, providing the visual summary of the first video content item for playback.

7. The method of claim 1, wherein occurrence of the one or more transitional indicators in the one-dimensional or multidimensional signal corresponds to a gradual transition between shots in the first video content item.

8. The method of claim 1, wherein occurrence of a step function as a transition indicator of the one-dimensional or multidimensional signal corresponds to an abrupt change between shots in the first video content item.

9. The method of claim 1, further including, storing the respective key frames as a second visual summary.

10. The method of claim 1, wherein the one or more transitional indicators comprises one or more of the group consisting of: changes in linear functions, changes in non-linear functions, and step functions of the one-dimensional or multidimensional signal.

11. The method of claim 1, wherein generating the visual summary of the first video content item based on the one or more of the respective key frames comprises clustering the one or more of the respective key frames.

12. A computer system comprising:
one or more processors; and
memory storing one or more programs, the one or more programs including instructions for:
extracting, from a first video content item that includes a plurality of frames, a plurality of features;
segmenting the first video content item into respective shots using change-point detection of the plurality of features, including:
representing the plurality of features as a one-dimensional or multi--dimensional signal over time;
identifying a change from one respective shot to another respective shot based on occurrence of one or more transitional indicators of the one-dimensional or multi-dimensional signal, wherein the first video content item is segmented into respective shots at the identified changes;
selecting, from each respective shot, a respective key frame; and
generating a visual summary of the first video content item based on one or more of the respective key frames.

13. The computer system of claim 12, wherein selecting the respective key frame includes determining a relative position of the respective key frame to other frames within the respective shot and selecting the respective key frame based on its relative position.

14. The computer system of claim 12, wherein selecting the respective key frame includes determining a brightness and/or variance of a Laplacian of the frames in the respective shot and selecting the respective key frame based on the brightness and/or the variance of the Laplacian of the frames in the respective shot or a combination thereof.

15. The computer system of claim 12, wherein selecting the respective key frame based on a smallest average distance between the respective key frame and one or more other frames in the respective shot.

16. The computer system of claim 12, wherein the visual summary comprises a second video content item that includes a cluster of one or more respective key frames.

17. The computer system of claim 12, further including, providing the visual summary of the first video content item for playback.

18. The computer system of claim 12, wherein occurrence of the one or more transitional indicators in the one-dimensional or multidimensional signal corresponds to a gradual transition between shots in the first video content item.

19. The computer system of claim 12, wherein occurrence of a step function as a transition indicator of the one-dimensional or multidimensional signal corresponds to an abrupt change between shots in the first video content item.

20. A non-transitory computer-readable storage medium storing one or more programs for execution by a computer system with one or more processors, the one or more programs comprising instructions for:
extracting, from a first video content item that includes a plurality of frames, a plurality of features;
segmenting the first video content item into respective shots using change-point detection of the plurality of features, including:
representing the plurality of features as a one-dimensional or multi--dimensional signal over time;
identifying a change from one respective shot to another respective shot based on occurrence of one or more transitional indicators of the one-dimensional or multi-dimensional signal, wherein the first video content item is segmented into respective shots at the identified changes;
selecting, from each respective shot, a respective key frame; and
generating a visual summary of the first video content item based on one or more of the respective key frames.
